(19) United States
(12) Patent Application Publication
(10) Pub. No.: US 2007/0045279 A1
(43) Pub. Date: Mar. 1, 2007

(54) Heating element used in diffusion furnaces

(75) Inventors: Arsalan Alan Emami, Aliso Viejo, CA (US); Mitch Agamohamadi, Orange, CA (US); Saeed Sedehi, Orange, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: NexTherm, Inc.

(21) Appl. No.: 11/512,007

(22) Filed: Aug. 28, 2006

Related U.S. Application Data
(60) Provisional application No. 60/712,597, filed on Aug. 29, 2005.

(51) Int. Cl. H05B 3/68

(52) U.S. Cl. 219/461.1

(57) ABSTRACT

An embodiment of the present invention is a heating element structure. A first strip wire shaped in a wave-like configuration is attached to an insulator surface by a plurality of staples placed along the first strip wire.

### RELATED APPLICATION

This patent application claims the benefits of U.S. Provisional Application, titled “Heating Element Used In Diffusion Furnaces”, Ser. No. 60/712,597, filing date Aug. 29, 2005.

### BACKGROUND

1. Field of the Invention

Embodiments of the invention relate to the field of furnaces, and more specifically, to heating element structure in furnaces.

2. Description of Related Art

Furnaces typically use resistance wires as heating elements. Many applications using furnaces require the heaters to be responsive to temperature changes and maintain a uniform temperature over some time period. A resistance wire typically goes through many thermal cycles during its life. Resistance wires expand, grow, or elongate due to exposure to high temperatures over time.

Existing techniques to provide reliable wire heating elements have a number of drawbacks. One technique uses round resistance wire. Different wire diameters are utilized for different temperature ranges. The existing designs and use of round wire have shortcomings, which lead to a shorter heater element life. The most common cause of failure of existing heater elements used in semiconductor equipment is associated with the growth of wire with usage and time. As a heating element cycles between higher and lower temperatures, its linear length increases. Prior art designs do not provide any space for growth of the resistance wire. The other failure mechanism is failure of the heater due to wire deformation resulting in separation of the power terminal and resistance wire. This separation results in disruption of electrical current delivered to the resistance wire, thus prohibiting heater operation.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system in which one embodiment of the invention may be practiced.

FIG. 2 is a diagram illustrating a heating core with ring strip wires according to one embodiment of the invention.

FIG. 3 is a diagram illustrating a ring strip wire according to one embodiment of the invention.

FIG. 4 is a diagram illustrating a heating core with strip wires on boards according to one embodiment of the invention.

FIG. 5 is a diagram illustrating a strip wire on a board according to one embodiment of the invention.

FIG. 6 is a diagram illustrating control locations on a strip wire according to one embodiment of the invention.

FIG. 7 is a diagram illustrating wave-like configuration according to one embodiment of the invention.

FIG. 8 is a diagram illustrating cross-sectional shape of strip wire according to one embodiment of the invention.

FIG. 9 is a flowchart illustrating a process to form a heating element according to one embodiment of the invention.

FIG. 10 is a flowchart illustrating a process to attach the strip wire according to one embodiment of the invention.

FIG. 11 is a flowchart illustrating a process to place staples at control points according to one embodiment of the invention.

### DESCRIPTION

An embodiment of the present invention is a heating element structure. A first strip wire shaped in a wave-like configuration is attached to an insulator surface by a plurality of staples placed along the first strip wire. The staples secure the strip wire at a plurality of locations to constrain the movement of the strip wires due to a thermal effect. The staples also guide the strip wires at a plurality of second locations to allow the strip wires to move due to the thermal effect.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

An embodiment of the invention is a heating element structure used in a furnace. The furnace may be positioned horizontally or vertically. The furnace includes a heating core. The heating core includes an insulator layer and heating elements. The heating elements are strip wires. The strip wires have resistance selected to generate heat when power is applied. The strip wires have a directional movement under a thermal effect such as when power is applied. The strip wires have wave-like pattern and are attached to an insulator surface by staples at control locations to allow expansion or contraction of the wires locally at spaces at designated locations. By providing the space to allow growth of the heating element, the life of the heating element may be prolonged, avoiding premature failure. In addition, the heating element structures are simple to construct, allowing easy construction of the heating core and reducing assembly costs.

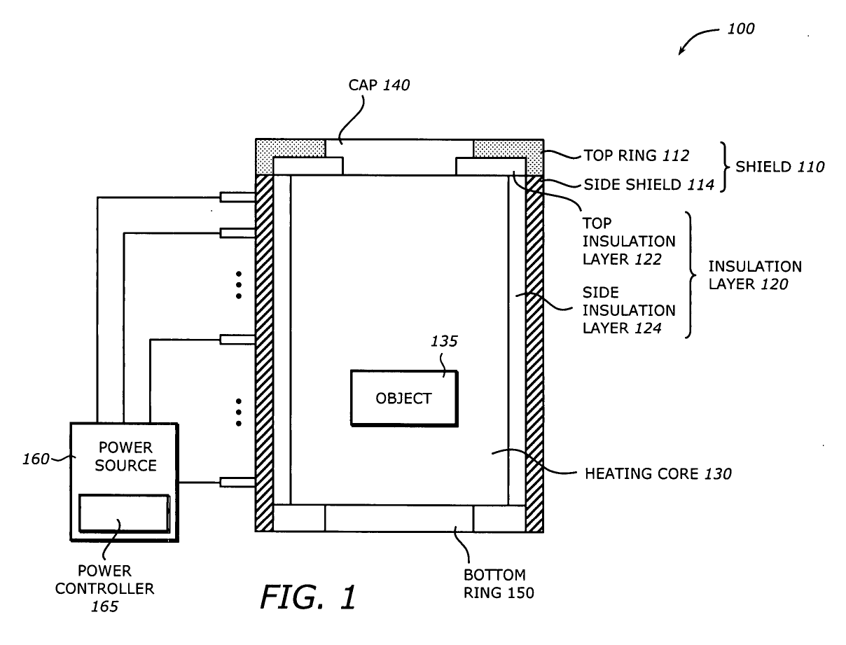

FIG. 1 is a diagram illustrating a system 100 in which one embodiment of the invention may be practiced. The system 100 represents a diffusion furnace used to generate heat in thermal design or control applications. The system 100 includes a shield 110, an insulation layer 120, a heating core 130, a cap 140, a bottom ring 150, and a power source 160. Note that the system 100 may have more or less than the above components.

The shield, or shell, 110 provides a housing or enclosure to house or enclose the heating core 130. It may be made of stainless steel. It may include a top ring 112 to shield the top of the heating core 130 and a side shield 114. Typically the shield 110 has a shape of a circular, oval, or elliptic cylinder. The shield 110 may have structures, parts, or elements to provide mechanical and electrical support for power bars and thermocouples.

The insulation layer 120 provides insulation for the heating core 130. The insulation layer 120 includes a top insulation layer 122 and a side insulation layer 124. The insulation layer 120 may be made of any material that is highly resistant to heat, has a low temperature expansion coefficient, has a low heat transfer coefficient, and maintains its properties over time. An example of such material is a mixture of aluminum oxide (Al₂O₃) and silicon dioxide or silica (SiO₂). As is known by one skilled in the art, any other insulating materials having the above desirable characteristics may be used.

The heating core 130 provides heat generation to an object 135 placed inside the core. The object 135 may be any object, structure, element, or component that needs to be heated at some pre-defined temperature range. In one embodiment, the object 135 is a semiconductor wafer. The temperature range may be any suitable range as required, from 25° C. to 1700° C. For example, for semiconductor wafer applications, the temperature range may be between 500° C. to 1200° C. The heating core 130 has power bars to connect to the power source 160. The heating core 130 may provide heat to a number of zones inside the heating core 130. The heating zones may have different temperature ranges according to the requirements and specifications of the furnace. The power bars are allocated to correspond to the heating zones.

The cap 140 seals the heating core 130 at the top and provides a tight mechanical fit to the top ring 112 to reduce or minimize heat loss. The bottom ring 150 provides mechanical support for the heating core 130.

The power source 160 provides power to the heating core to generate heat when power is applied. The power source 160 is connected to the heating core 130 via the power bars. The power source 160 may have a power controller 165 that controls the amount of current and/or voltage to the heating core 130. By receiving different amounts of current or voltage via the individual power bars, the heating core 130 is able to generate different heat profiles in the corresponding heating zones.

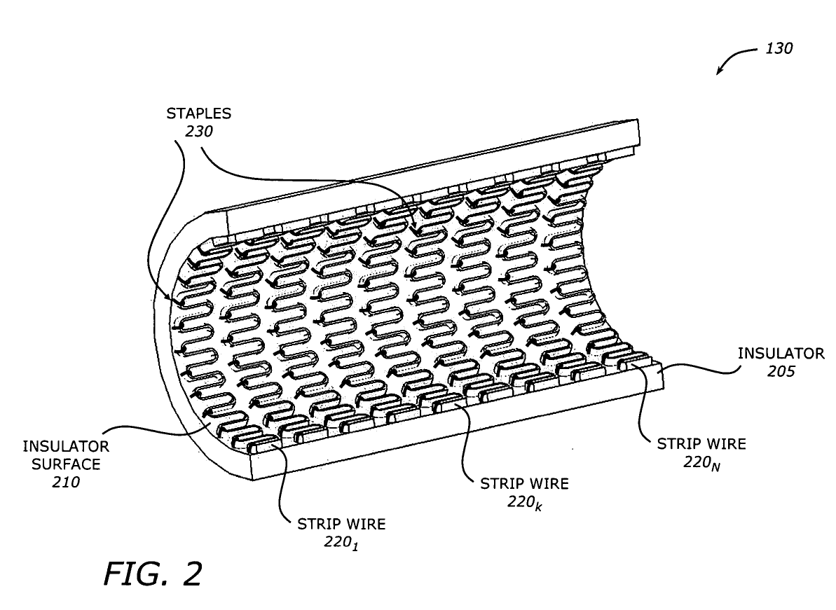

FIG. 2 is a diagram illustrating the heating core 130 with ring strip wires according to one embodiment of the invention. The heating core 130 includes an insulator layer 205 and N heating elements 220₁ to 220_{N}.

The insulator layer 205 may be the side insulator 124 (FIG. 1), or any other insulator. It has an insulator surface 210. Typically, the insulator layer 205 forms a cylindrical shape. The cross section of the insulator layer 205 may be a circle or an ellipsoid.

The heating elements 220₁ to 220_{N} may be strip wires. Each of the strip wires 220₁ to 220_{N} may be shaped in a wave-like configuration and may have a cross-sectional area that is different than the prior art round area. The strip wires 220₁ to 220_{N} are attached to the insulator surface 210 by a number of staples 230 that are placed along the strip wires at control locations to control the direction of movement of the strip wires 220₁ to 220_{N} when the strip wires 220₁ to 220_{N} move (e.g., expand, contract) due to thermal effect. Each of the strip wires 220₁ to 220_{N} fits inside the insulator layer 205 such that it forms a ring. Typically, the ring is circular or substantially circular according to the cross section of the insulator layer 205.

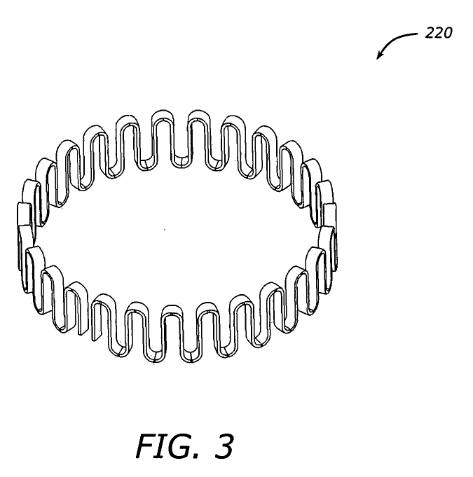

FIG. 3 is a diagram illustrating a ring strip wire 220 according to one embodiment of the invention.

The ring strip wire 220 is one of the heating elements 220₁ to 220_{N}. It is shaped in a wave-like configuration and forms a ring that fits inside the insulator layer 205 (FIG. 2). The two ends of the strip wire 220 are connected together so that the strip wire 220 becomes a closed ring.

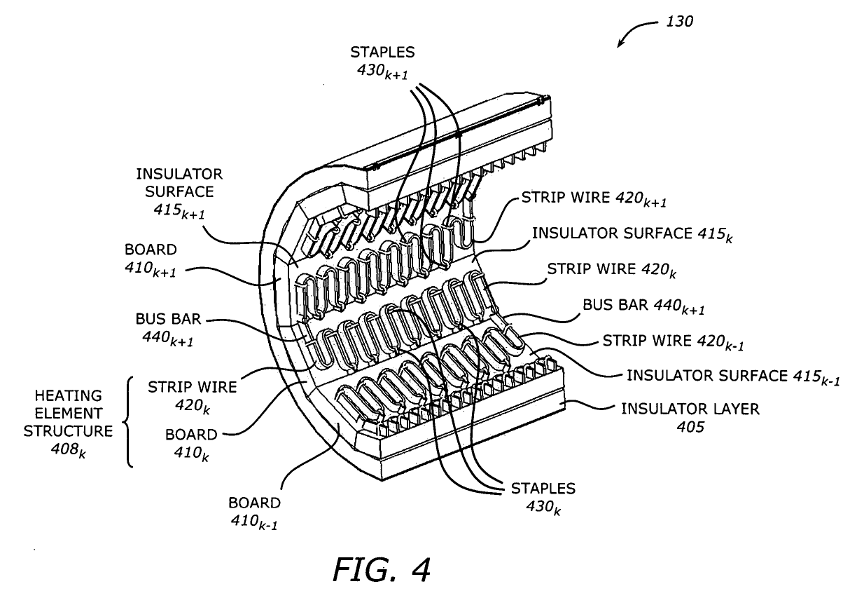

FIG. 4 is a diagram illustrating the heating core 130 with strip wires on boards according to one embodiment of the invention. The heating core 130 includes an insulator layer 405 and a plurality of heating element structure 408ₖ's (k=1, . . . , P).

The insulator layer 405 is essentially similar to the insulator 205 (FIG. 2) or 124 (FIG. 1). Its surface, however, is attached to the bottom surfaces of the heating element structures 408ₖ's, and not directly to the heating elements or strip wires.

The heating element structure 408ₖ's are arranged and positioned such that they fill up the inner surface of the insulator layer 405. The number P of the heating element structure 408ₖ's may be determined according to the periphery of the inner surface of the insulator layer 405 and the size of each of the heating element structure 408ₖ's. For illustrative purposes, FIG. 4 shows three heating element structures 408ₖ₋₁, 408ₖ, and 408ₖ₊₁ that are placed next to each other.

The heating element structure 408ₖ includes a board 410ₖ and a strip wire 420ₖ. The board 410ₖ has an insulator surface 415ₖ. The insulator surface 415ₖ may be flat or somewhat curved. The strip wire 420ₖ is attached to the insulator surface 415ₖ by a plurality of staples 430ₖ placed along the strip wire 420ₖ at control locations to control the direction of movement of the strip wire 420ₖ when the strip wires 420ₖ moves (e.g., expands, contracts) due to thermal effect. Similarly, the heating element structure 408ₖ₊₁ includes a board 410ₖ₊₁ and a strip wire 420ₖ₊₁. The board 410ₖ₊₁ has an insulator surface 415ₖ₊₁. The insulator surface 415ₖ₊₁ may be flat or somewhat curved. The strip wire 420ₖ₊₁ is attached to the insulator surface 415ₖ by a plurality of staples 430ₖ₊₁ placed along the strip wire 420ₖ₊₁. The heating element structure 408ₖ₋₁ is similar, having a board 410ₖ₋₁, a strip wire 420ₖ₋₁, an insulator surface 415ₖ₋₁, and staples 430ₖ₋₁. The strip wire 420ₖ is attached to the strip wire 420ₖ₊₁ by a bus bar 440ₖ at one end and to the strip wire 420ₖ₋₁ by a bus bar 440ₖ₋₁ at the other end.

The heating element structure 408ₖ's are placed vertically, i.e., in the upright direction. In other words, the strip wires 420ₖ's are also placed vertically. The size of the boards 410ₖ's or the strip wires 420ₖ's may be selected so that the heating element structures 408ₖ's fill up completely the inner surface of the insulator layer 405. In one embodiment, the heating element structures 408ₖ's may fill up partially on the inner surface of the insulator layer 405. Typically, the length of each of the boards 410ₖ's fits the length of the insulator layer 405.

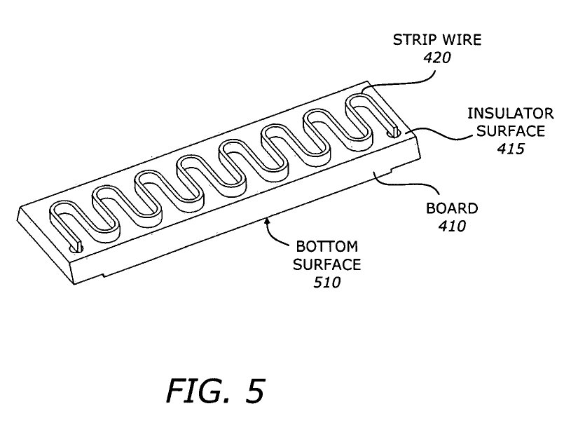

FIG. 5 is a diagram illustrating the strip wire 420 on a board according to one embodiment of the invention.

The board 410 has the insulator surface 415 and a bottom surface 510. The insulator surface 415 is attached to the strip wire 420. The bottom surface 510 is attached to, or placed on, the inner surface of the insulator layer 405 (FIG. 4). The strip wire 420 has a wave-like configuration that may be flat or slightly curved when placed on the insulator surface 415 of the board 410. The insulator surface 415 may be slightly curved to fit the curvature of the portion of the inner surface of the insulator layer 405 on which the board 410 is placed. The insulator surface 415 may be flat while the bottom surface 510 may be curved to fit the curvature of the portion of the inner surface of the insulator layer 405 on which the board 410 is placed. The bottom surface 510 may also be flat.

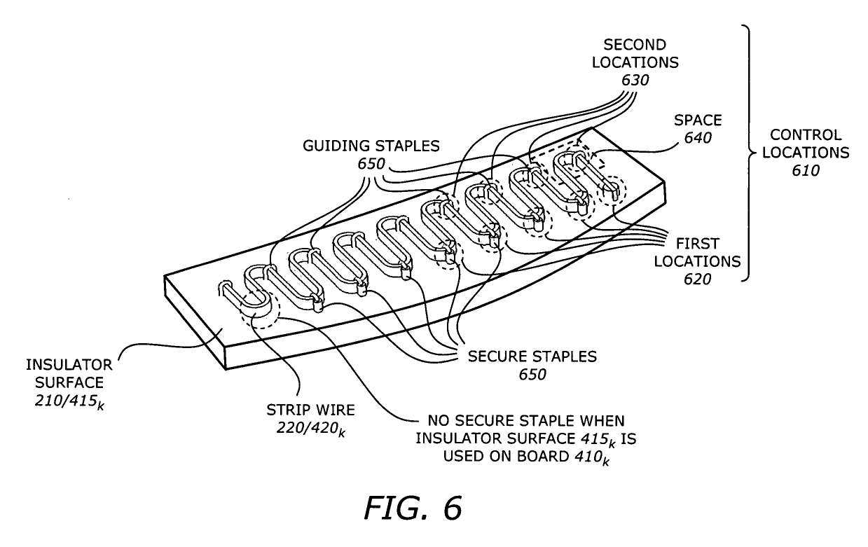

FIG. 6 is a diagram illustrating control locations 610 on the strip wire 220/420ₖ according to one embodiment of the invention. The control locations 610 include a plurality of first locations 620 and a plurality of second locations 630. The staples 430ₖ include secure staples 650 and guiding staples 660.

The first locations 620 are located at the peaks on one side of the wave-like configuration or pattern. The secure staples 650 secure the strip wire 220/420ₖ at the first locations 620 to constrain movement of the strip wire 220/420ₖ. The secure staples 650 may firmly or tightly hold the strip wire 220/420ₖ onto the insulator surface 210/415ₖ. At these locations, the strip wire 220/420ₖ may not move much under a thermal effect. The thermal effect may include a temperature increase during heating or a temperature decrease during cooling. Typically, during temperature increase, the strip wire 220/420ₖ expands or elongates; and during temperature decrease, the strip wire 220/420ₖ contracts or shrinks.

Note that the illustration of the control location 610 is applicable for both the ring strip wire 220 and the board strip wire 420ₖ. When the insulator surface is the insulator surface 415ₖ of the board 410ₖ, the end of the strip wire 420ₖ is connected to the end of the adjacent strip wire 420ₖ₊₁ by a bus bar as explained above. At this end, it is not necessary to secure the strip wire 420k by a secure staple. This is to allow the strip wire 420ₖ to move within the space where the bus bar is connected to the two ends. In other words, the first locations 620 do not include a location at an end of the strip wire 420ₖ where it is connected to the strip wire 420ₖ₊₁, or 420ₖ₋₁, by the bus bar.

The second locations 630 are located near or at peaks on opposite side of the wave-like configuration. They may be located within approximately 50% of the segments of the wave-like pattern of the strip wire 220/420ₖ. The guiding staples 660 guide the strip wire 220/420ₖ to allow them to expand or contract in a space 640 due to the thermal effect. At the second locations 630, the strip wire 220/420ₖ freely moves (e.g., expands, contracts) locally within the space 640 guided by the staples. The expansion or contraction of the strip wire 220/420ₖ is therefore distributed locally at the second locations 630. This may reduce the strain or stress on the strip wire 220/420ₖ. The guiding staples 660 at these locations act as a guide to guide the movement of the strip wire 220/420ₖ. The guiding staples 660 hold the strip wire 220/420ₖ loosely. There may be as many guiding staples 660 as necessary to guide the movement of the strip wire 220/420ₖ. The space 640 may have a size of 0.01 inch to 100 inches depending on the size of the strip wire 220/420ₖ and/or their wave-like configuration.

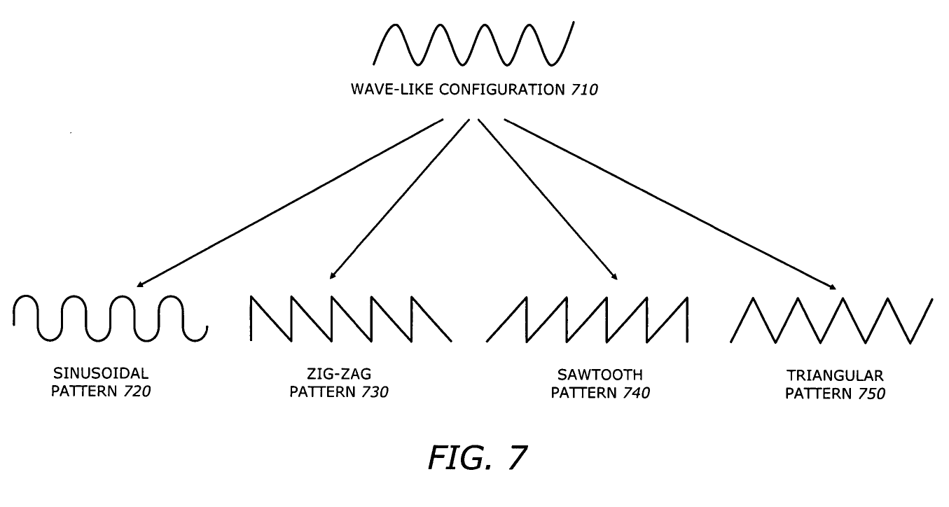

FIG. 7 is a diagram illustrating a wave-like configuration 710 according to one embodiment of the invention. The wave-like configuration 710 is any pattern that has a wavy pattern with peaks and valleys. These include, but are not limited to, a sinusoidal pattern 720, a zigzag pattern 730, a saw-tooth pattern 740, and a triangular pattern 750. Typically, the strip wires 220/420ₖ may be shaped with some curvature at the peaks or valleys

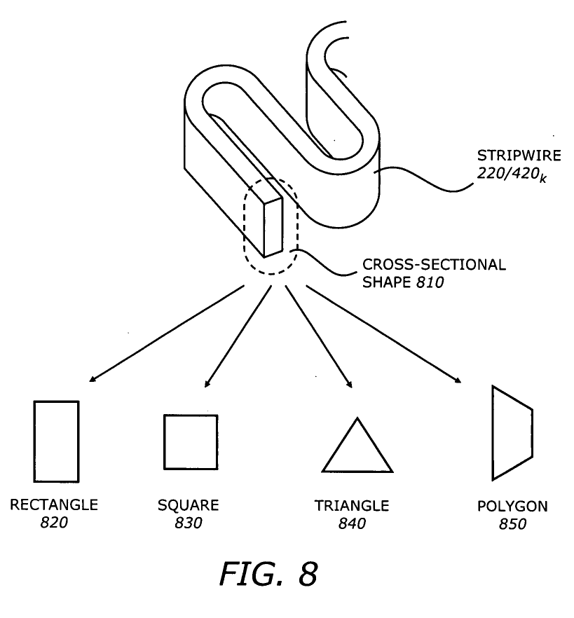

FIG. 8 is a diagram illustrating a cross-sectional shape 810 of strip wire according to one embodiment of the invention. The shape of the cross section of the strip wire may be anything other than the prior art round shape. It may be a rectangle 820, a square 830, a triangle 840, and a polygon 850.

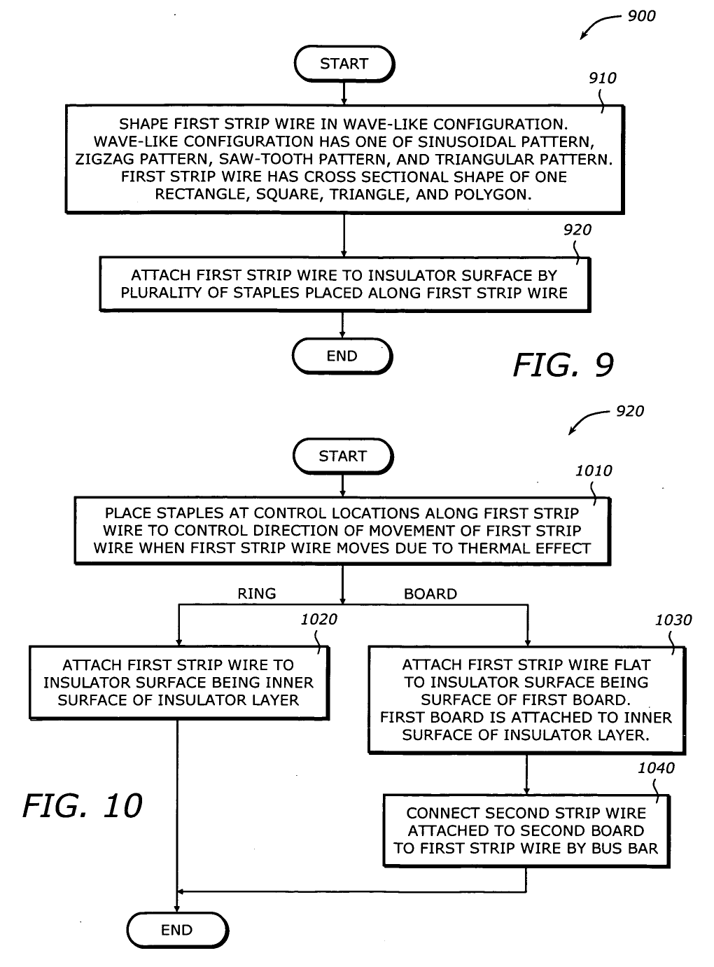

FIG. 9 is a flowchart illustrating a process 900 to form a heating element according to one embodiment of the invention.

Upon START, the process 900 shapes or bends a first strip wire in a wave-like configuration (Block 910). The wave-like configuration has one of a sinusoidal pattern, a zigzag pattern, a saw-tooth pattern, and a triangular pattern. The first strip wire has a cross sectional shape of one of a rectangle, a square, a triangle, and a polygon.

Next, the process 900 attaches the first strip wire to an insulator surface by a plurality of staples placed along the first strip wire (Block 920). The process 900 is then terminated.

FIG. 10 is a flowchart illustrating the process 920 to attach the strip wire according to one embodiment of the invention.

Upon START, the process 920 places the staples at control locations along the first strip wire to control direction of movement of the first strip wire when the first strip wire moves due to thermal effect (Block 1010). The thermal effect may include temperature increase or decrease. Next, the process 920 branches into two paths depending on the particular embodiment. One embodiment uses ring strip wires and another embodiment uses boards.

In the embodiment using ring strip wires, the process 920 attaches the first strip wire to the insulator surface being an inner surface of an insulator layer (Block 1020). The first strip wire is formed into a circular ring fitting the inner surface of the insulator layer. The process 920 is then terminated.

In the embodiment using boards, the process 920 attaches the first strip wire flat to the insulator surface being a surface of a first board (Block 1030). The insulator surface may be flat or slightly curved. The first board has a bottom surface attached to an inner surface of the insulator layer. The bottom surface may be flat or slightly curved to fit the curvature portion of the inner surface on which the board is placed. Next, the process 920 connects a second strip wire attached to a second board to the first strip wire by a bus bar (Block 1040). The process 920 is then terminated.

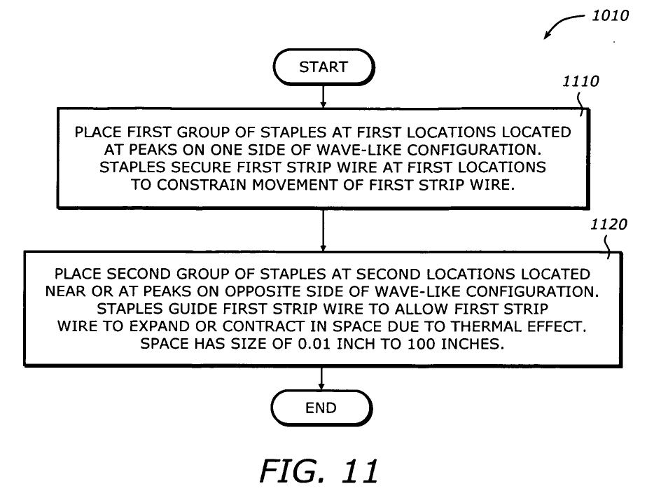

FIG. 11 is a flowchart illustrating the process 1010 to place staples at control points according to one embodiment of the invention.

Upon START, the process 1010 places a first group of staples at a plurality of first locations located at peaks on one side of the wave-like configuration (Block 1110). These staples secure the first strip wire at the first locations to constrain movement of the first strip wire under thermal effect.

Next, the process 1010 places a second group of staples at a plurality of second locations located near or at peaks on opposite side of the wave-like configuration (Block 1120). These staples guide the first strip wire to allow first strip wire to expand or contract in a space due to the thermal effect. The space may have a size of 0.01 inch to 100 inches. The process 1010 is then terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
an insulator surface; and
a first strip wire shaped in a wave-like configuration attached to the insulator surface by a plurality of staples placed along the first strip wire.

2. The apparatus of claim 1 wherein the staples are placed at control locations along the first strip wire to control direction of movement of the first strip wire when the first strip wire moves due to thermal effect.

3. The apparatus of claim 2 wherein the control locations comprises:
a plurality of first locations located at peaks on one side of the wave-like configuration; and
a plurality of second locations located near or at peaks on opposite side of the wave-like configuration.

4. The apparatus of claim 3 wherein the staples secure the first strip wire at the plurality of the first locations to constrain movement of the first strip wire and guide the first strip wire at the plurality of the second locations to allow the first strip wire to expand or contract in a space due to the thermal effect.

5. The apparatus of claim 1 wherein the space having a size of 0.01 inch to 100 inches.

6. The apparatus of claim 1 wherein the wave-like configuration has one of a sinusoidal pattern, a zigzag pattern, a saw-tooth pattern, and a triangular pattern.

7. The apparatus of claim 1 wherein the first strip wire has a cross sectional shape of one of a rectangle, a square, a triangle, and a polygon.

8. The apparatus of claim 1 wherein the first strip wire forms a ring fitting the insulator surface being an inner surface of an insulator layer.

9. The apparatus of claim 3 wherein the first strip wire is attached to the insulator surface being a surface of a first board, the first board being attached to an inner surface of an insulator layer.

10. The apparatus of claim 9 further comprising:
a second board having a second strip wire attached thereon, the second strip wire being connected to the first strip wire by a bus bar.

11. The apparatus of claim 10 wherein the plurality of the first locations does not include a location at end of the first strip wire where the first strip wire is connected to the second strip wire by the bus bar.

12. A method comprising:
shaping a first strip wire in a wave-like configuration; and
attaching the first strip wire to an insulator surface by a plurality of staples placed along the first strip wire.

13. The method of claim 12 wherein attaching the first strip wire comprises placing the staples at control locations along the first strip wire to control direction of movement of the first strip wire when the first strip wire moves due to thermal effect.

14. The method of claim 13 wherein placing the staples at the control locations comprises:
placing a first group of the staples at a plurality of first locations located at peaks on one side of the wave-like configuration; and
placing a second group of the staples at a plurality of second locations located near or at peaks on opposite side of the wave-like configuration.

15. The method of claim 14 wherein placing the staples at the control locations comprises:
placing the first group of the staples at the plurality of first locations to secure the first strip wire at the plurality of the first locations to constrain movement of the first strip wire; and
placing the second group of the staples at the plurality of second locations to guide the first strip wire to allow the first strip wire to expand or contract in a space due to the thermal effect.

16. The method of claim 12 wherein the space having a size of 0.01 inch to 100 inches.

17. The method of claim 12 wherein the wave-like configuration has one of a sinusoidal pattern, a zigzag pattern, a saw-tooth pattern, and a triangular pattern.

18. The method of claim 12 wherein the first strip wire has a cross sectional shape of one of a rectangle, a square, a triangle, and a polygon.

19. The method of claim 14 wherein attaching further comprises attaching the first strip wire to the insulator surface being an inner surface of an insulator layer, the first strip wire being formed into a ring fitting the inner surface of the insulator layer.

20. The method of claim 14 wherein attaching further comprises attaching the first strip wire flat to the insulator surface being a surface of a first board, the first board being attached to an inner surface of an insulator layer.

21. The method of claim 20 wherein attaching further comprises:
connecting a second strip wire attached to a second board to the first strip wire by a bus bar.

22. The method of claim 21 wherein the plurality of the first locations does not include a location at end of the first strip wire where the first strip wire is connected to the second strip wire by the bus bar.

23. A furnace comprising:
a shield;
an insulation layer enclosed by the shield; and
a heating core enclosed by the insulation layer, the heating core comprising a plurality of heating elements, each of the heating elements comprising:
a first strip wire shaped in a wave-like configuration attached to an insulator surface by a plurality of staples placed along the first strip wire.

24. The furnace of claim 23 wherein the staples are placed at control locations along the first strip wire to control direction of movement of the first strip wire when the first strip wire moves due to thermal effect.

25. The furnace of claim 24 wherein the control locations comprises:
a plurality of first locations located at peaks on one side of the wave-like configuration; and
a plurality of second locations located near or at peaks on opposite side of the wave-like configuration.

26. The furnace of claim 25 wherein the staples secure the first strip wire at the plurality of the first locations to constrain movement of the first strip wire and guide the first strip wire at the plurality of the second locations to allow the first strip wire to expand or contract in a space due to the thermal effect.

27. The furnace of claim 23 wherein the first strip wire forms a ring fitting the insulator surface being an inner surface of the insulator layer.

28. The furnace of claim 25 wherein the first strip wire is attached to the insulator surface being a surface of a first board, the first board being attached to an inner surface of the insulator layer.

29. The furnace of claim 28 further comprising:
a second board having a second strip wire attached thereon, the second strip wire being connected to the first strip wire by a bus bar.

30. The furnace of claim 29 wherein the plurality of the first locations does not include a location at end of the first strip wire where the first strip wire is connected to the second strip wire by the bus bar.
